(19) United States
(12) Patent Application Publication
(10) Pub. No.: US 2015/0278413 A1
(43) Pub. Date: Oct. 1, 2015

(54) Numerical Model For Rubber-like Materials Suitable For Computer Aided Engineering Analysis

(71) Applicant: Livermore Software Technology Corporation, Livermore, CA (US)

(72) Inventors: William W. Feng, Lafayette, CA (US); John O. Hallquist, Livermore, CA (US)

(73) Assignee: Livermore Software Technology Corporation, Livermore, CA (US)

(21) Appl. No.: 14/225,790

(22) Filed: Mar. 26, 2014

(51) Int. Cl. G06F 17/50

(52) U.S. Cl. CPC G06F 17/5018

(57) ABSTRACT

Systems and methods to create a numerical model for rubber-like material including Mullins effect based on test data obtained in a bi-axial tension test of a specimen of a rubber-like material of interest are disclosed. Based on inflating-pressure versus displacement-at-the-pole data, first set of constants of the Mooney-Rivlin constitutive equation used as strain-energy density function are determined in the loading phase. Second set of numerical constants in an unloading-phase damage function are determined. The unloading-phase damage function is used for modifying the strain-energy density function in the unloading phase and contains a hyperbolic tangent function with dimensionless operands that include a peak strain energy value occurred immediately before the unloading phase. Third set of constants in a subsequent reloading-phase damage function are determined. The subsequent reloading-phase damage function is used for modifying the strain-energy density function in the reloading phase.

### FIELD

The present invention generally relates to computer-aided engineering (CAE) analysis (e.g., finite element analysis), more particularly to methods and systems for creating a numerical model for rubber-like materials suitable for computer-aided engineering analysis based on results obtained in a bi-axial tension test.

### BACKGROUND

Rubber-like materials such as elastomers have been used in many parts and structures in various industries (e.g., automotive, aerospace, etc.) for years. But the mechanical properties (e.g., stress-strain or stress-stretch ratio relationship) of elastomer, other than the elastic properties, are still not clearly defined hence, designs and analyses (especially used in computer-aided engineering) of these structures are generally based on the elastic properties of the elastomer only. In reality, elastomers exhibit non-elastic effects such as the Mullins effect, viscoelastic, and chronorheological behavior, and the magnitudes of the non-elastic properties are often large enough that they should not be neglected.

Elastomer in its virgin state exhibits a relatively stiffer response on the initial loading. When the elastomer is loaded, subsequently unloaded, then reloaded, the stress-strain relationship follows a significantly softer path. After several unloading-reloading cycles, the stress-strain relationship stabilizes, and additional unloading-reloading cycles retrace the stabilized path in the stress-strain curve. The non-elastic material behavior of elastomer described herein is referred to as the Mullins effect, in which the stress-strain relationship depends on the maximum loading previously encountered.

To date, very few analytical and experimental studies for determining non-elastic properties of elastomers have been attempted. This is because the study of mechanics for elastomers must consider both geometric and material nonlinearities. The additional effects and the lack of an adequate constitutive equation that describes these phenomena make the analytical and experimental studies very difficult.

Prior art numerical equations (i.e., constitutive equations) are not adequate to represent true behaviors of elastomers. One of the prior art constitutive equations assumes the loading and subsequent reloading paths are the same, which does not represent the true behaviors of elastomers due to the fact that elastomers should become softer in a subsequent reloading path than in the original loading path.

Furthermore, although some prior art approaches include a damage function to represent the Mullins effect in unload and reload phases. However, the damage function is dimension dependent and tied to stresses of the rubber-like material. As a result, it is very difficult to correlate and apply such a damage function in real world applications.

Therefore, it would be desirable to have improved methods and systems to create a numerical model for rubber-like materials including the Mullins effects suitable for computer-aided engineering analysis.

### BRIEF SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Systems and methods to create a numerical model for a rubber-like material including the Mullins effect based on results obtained in a bi-axial tension test are disclosed. According to one aspect of the present invention, test results (i.e., pressure versus displacement-at-the-pole data) are obtained in a bi-axial tension test of a specimen of a rubber-like material of interest. The bi-axial tension test includes at least loading, unloading and reloading phases. Based on the pressure versus displacement-at-the-pole data, a first set of numerical constants of the Mooney-Rivlin constitutive equation are determined. The Mooney-Rivlin constitutive equation is used as strain-energy density function of the rubber-like material in the loading phase. Then, a second set of numerical constants in an unloading-phase damage function are determined. The unloading-phase damage function is used for modifying the strain-energy density function in the unloading phase and contains a hyperbolic tangent function with dimensionless operands that include a peak strain energy value occurred immediately before the unloading phase. Next, a third set of numerical constants in a subsequent reloading-phase damage function are determined. The subsequent reloading-phase damage function is used for modifying the strain-energy density function in the reloading phase. Finally, a numerical model of the rubber-like material suitable for computer-aided engineering analysis of a product made at least in-part of the rubber-like material is created by combining the Mooney-Rivlin equation, the unloading-phase damage function and the subsequent reloading-phase damage function along with the first, second and third sets of numerical constants.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a flowchart illustrating an exemplary process of creating numerical model of a rubber-like material of interest suitable for finite element analysis of a product made at least in-part of the rubber-like material in accordance with one embodiment of the present invention;

FIG. 2 is a diagram illustrating an exemplary stress versus stretch-ratio relationship (curves) of a rubber-like material under load-unload-reload phases showing Mullins effect in accordance with one embodiment of the present invention;

FIG. 3A is a diagram depicting an exemplary rubber-like material properties determination system (i.e., a bi-axial tension test device);

FIG. 3B is a diagram showing a lateral elevation view of the bi-axial tension test device of FIG. 3A;

FIG. 3C is a diagram showing components of an exemplary bi-axial tension test device of FIG. 3A;

FIG. 4 is a diagram showing an exemplary pressure versus displacement-at-the-pole curves generated by the rubber-like material properties determination system of FIG. 3A;

FIG. 5A lists the Mooney-Rivlin constitutive equation;

FIG. 5B lists damage functions used in accordance with an embodiment of the present invention;

FIG. 6 is a diagram showing correlation between test results and computed data in accordance with one embodiment of the present invention; and

FIG. 7 is a functional block diagram showing salient components of an exemplary computer, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

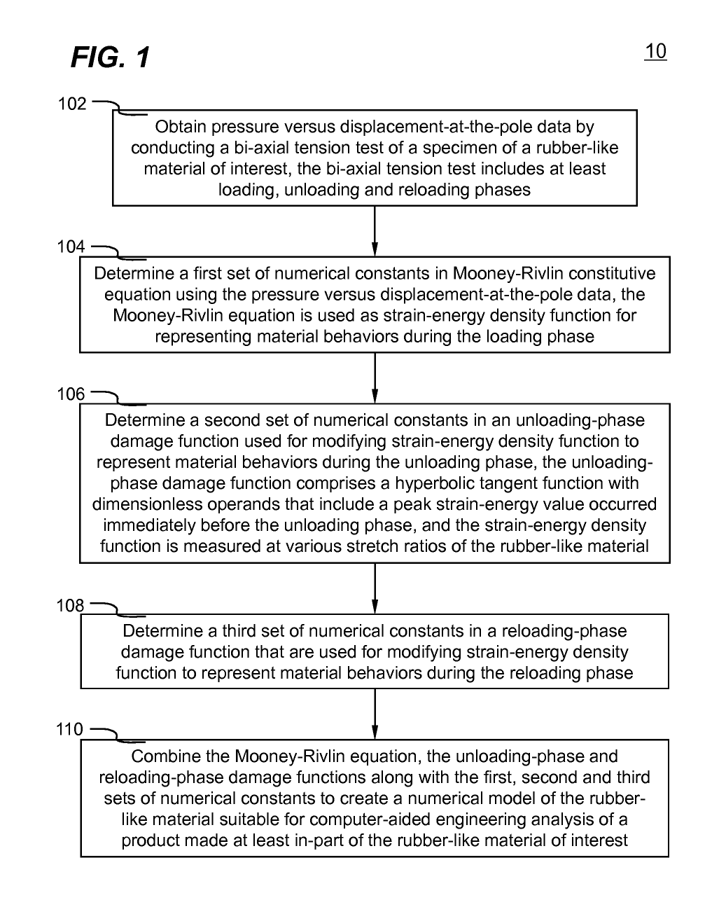

Embodiments of the present invention are discussed herein with reference to FIGS. 1-7. However, those skilled in the art will readily appreciate that the detailed description given herein with respect to these figures is for explanatory purposes as the invention extends beyond these limited embodiments.

Referring first to FIG. 1, it is shown a flowchart illustrating an exemplary process 10 of creating a numerical model of a rubber-like material of interest suitable for computer-aided engineering analysis in accordance with one embodiment of the present invention. Process 10 is preferably understood with other figures.

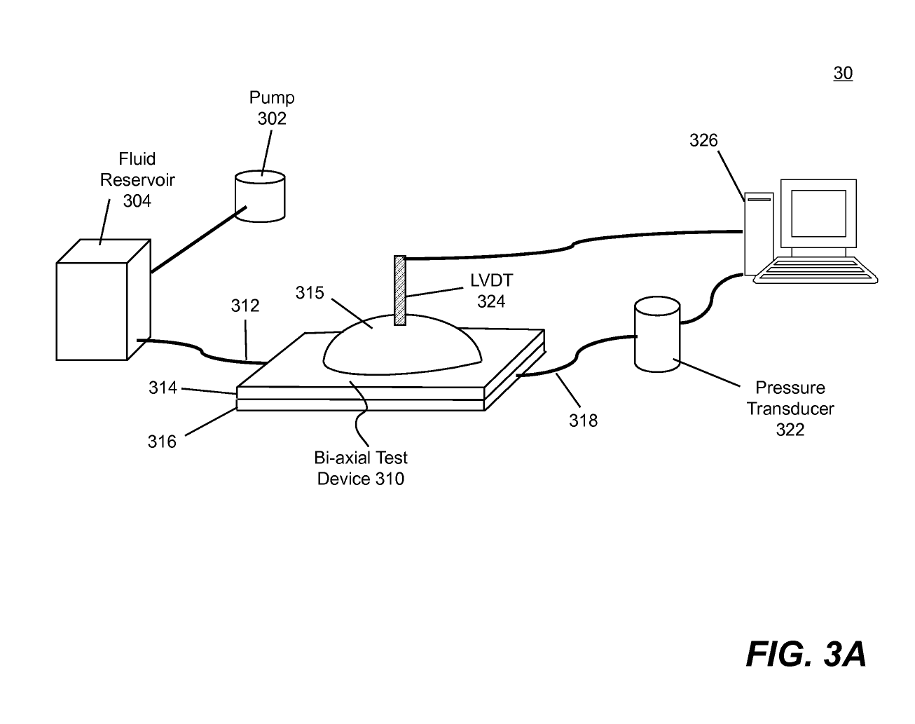

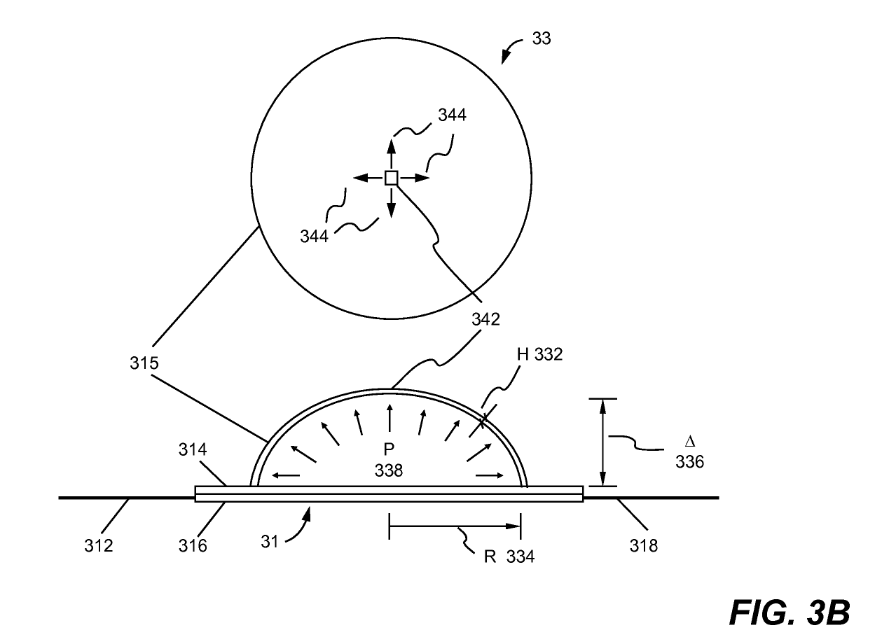

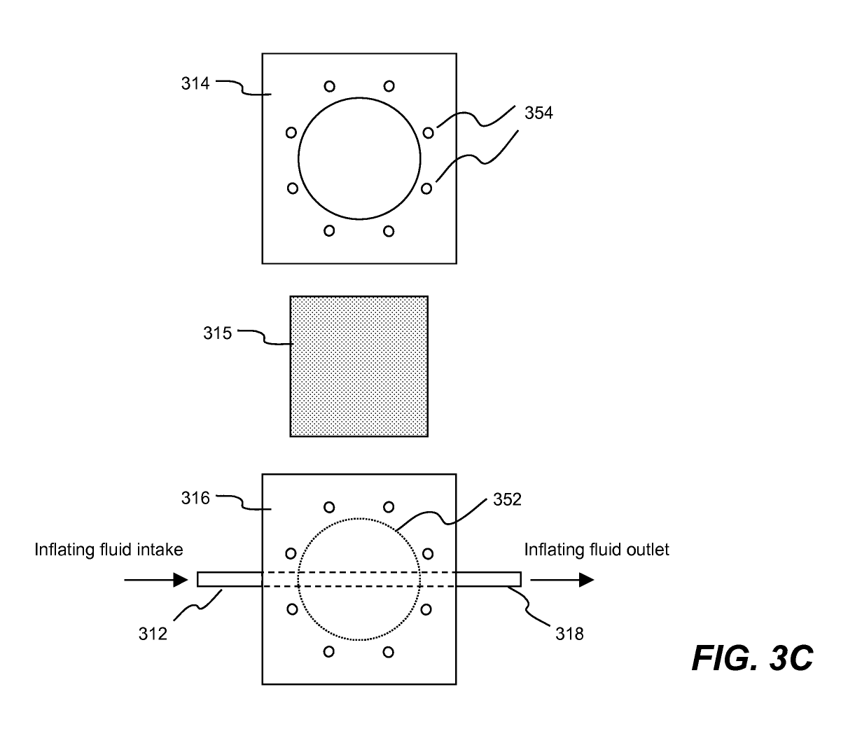

At step 102, process 10 starts by conducting a bi-axial tension test of a specimen of a rubber-like material of interest (e.g., elastomer). The bi-axial tension test includes at least loading, unloading and reloading phases such that Mullins effect of the rubber-like material is captured. FIGS. 3A-3C depict an exemplary bi-axial tension test system. The test results are pressure versus displacement-at-the-pole data of the specimen. A typical specimen has a circular shape with uniform thickness.

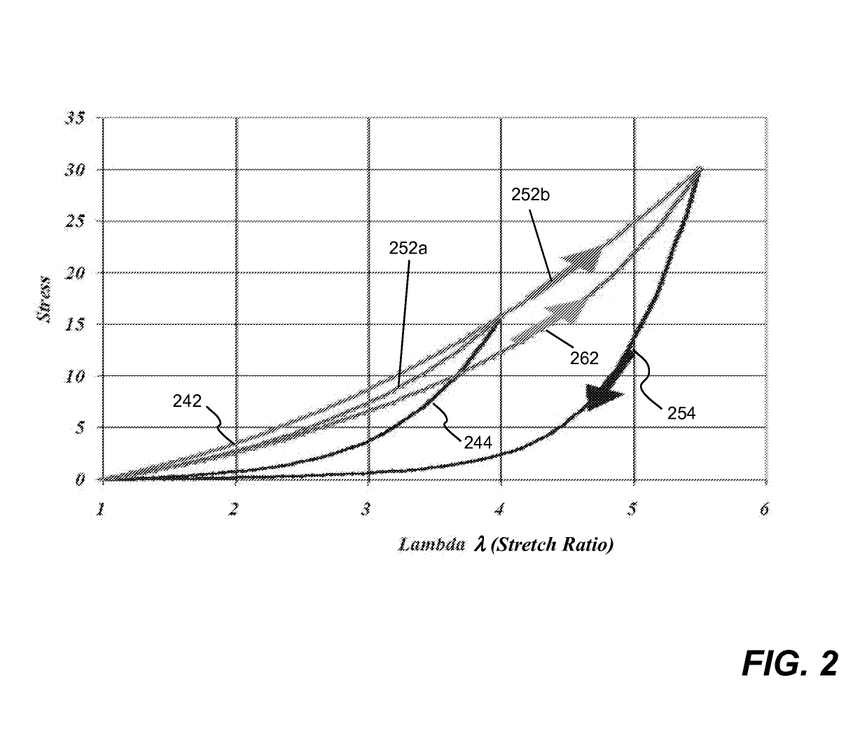

FIG. 2 shows stress versus stretch-ratio of a rubber-like material under a series of loading-unloading-reloading phases. The rubber-like material is first loaded following path 242, unloaded following path 244 and reloaded following path 252a-b. Then the rubber-like material is unloaded again following path 254 and reloaded following path 262. Evidently, the unloading paths and reloading paths are different from the loading paths. This physical phenomena is referred to as Mullins effect. The stretch-ratio λ is defined as the ratio between the final length and the initial length of the rubber-like material.

Referring now to FIGS. 3A-3C, an exemplary rubber-like material properties determination system 30 is shown. The system 30 comprises an inflating fluid subsystem and a data measurement subsystem, both coupling to a bi-axial tension test device 310. The bi-axial tension test device 310 comprises a top plate 314 and bottom plate 316. The top plate 314 includes a circular hole. The bottom plate 316 is a solid plate coupled with an inflating fluid intake 312 and with an inflating fluid outlet 318. A rubber-like material membrane specimen 315 is placed between the top plate 314 and the bottom plate 316 during a bi-axial tension test. The inflating fluid subsystem comprises a fluid reservoir 304 and a pump 302. The pump 302 is used for pumping inflating fluids (e.g., air or water), from the fluid reservoir 304 to the bi-axial tension test device 310, to inflate, deflate and re-inflate the rubber-like material membrane specimen 315. The data measurement subsystem includes a computer 326, a linear variable differential transformer (LVDT) 324 and a pressure transducer 322. The pressure transducer 322, coupling to the bi-axial tension test device 310 via the inflating fluid outlet 318, is configured to measure pressures of the inflating fluids throughout a bi-axial tension test. The LVDT 324 is configured to measure displacement-at-the-pole at the center of the rubber-like material membrane specimen 315 during the bi-axial tension test. Both the pressure transducer 322 and the LVDT 324 are coupled to the computer 326 (e.g., personal computer, server, laptop, desktop), which gathers and plots the measured data (i.e., pressure and displacement). The pump 302 is optionally configured to be controlled by the computer 326.

FIG. 3B shows a lateral elevation view 31 of the bi-axial tension test device 310 and a top view 32 of the rubber-like material membrane specimen 315 of FIG. 3A, according to an embodiment of the present invention. The rubber-like material specimen 315 has a uniform thickness H 332. As shown in the lateral view 31, the rubber-like material membrane specimen 315 is expanded up to a displacement-at-the-pole Δ 336 at the center 342 by a pressure 338 from the inflating fluids. The circular hole or opening of the top plate 314 has a radius R 334. The top view 32 shows that the membrane 315 at the center 342 is subjected to equal bi-axial tensions 344 as the rubber-like material membrane 315 is being expanded upwards by the pressure of the inflating fluids.

Sometime, a stiffer material will require higher inflating pressure, which may present a technical problem to achieve the higher pressure in a laboratory. The simplest way to solve this problem is to use either a larger size or a thinner specimen, for example, a membrane, doubled the size of radius or halved the thickness, will require one-half of the pressure to achieve a same displacement-at-the-pole. In one embodiment, typical size of the circular hole is relatively small with a radius between one to two inches.

The plane view of the top plate 314, the bottom plate 316 and the rubber-like material membrane specimen 315 (virgin state) are shown in FIG. 3C, according to an embodiment of the present invention. To conduct a bi-axial tension test, the rubber-like material membrane specimen 315 is sandwiched between the top plate 314 and the bottom plate 316. The top and bottom plates are securely coupled together with a plurality of screws. Each of the screws is screwed in a pair of screw holes 354, one in the top plate, the other the bottom plate. The circular hole or opening is so dimensioned that the specimen 315 can be expanded with a substantially low pressure (e.g., maximum of 15 psi).

In order to create a fluid-tight requirement for the bi-axial tension test, an O-ring is used for sealing the perimeter of the circular hole or opening. In one embodiment, two O-rings 352 are located on the top side of the bottom plate 316, while one corresponding O-ring (not shown) is located on the bottom side of the top plate 314. The rubber-like material membrane specimen 315 is so dimensioned that the size is large enough to cover the circular hole of the top plate 314, and to be able to form a fluid-tight environment with the top and the bottom plates. The rubber-like material membrane specimen 315 has a uniform thickness such that the inflating fluids inflate the specimen 315 uniformly. It is noted that shape of the top and bottom plates, number of screws, type of screws and O-rings are not limited to the embodiment as shown in FIG. 3C. Other means that can achieve the same purpose of providing a fluid-tight test environment with a circular hole may be used for the present invention.

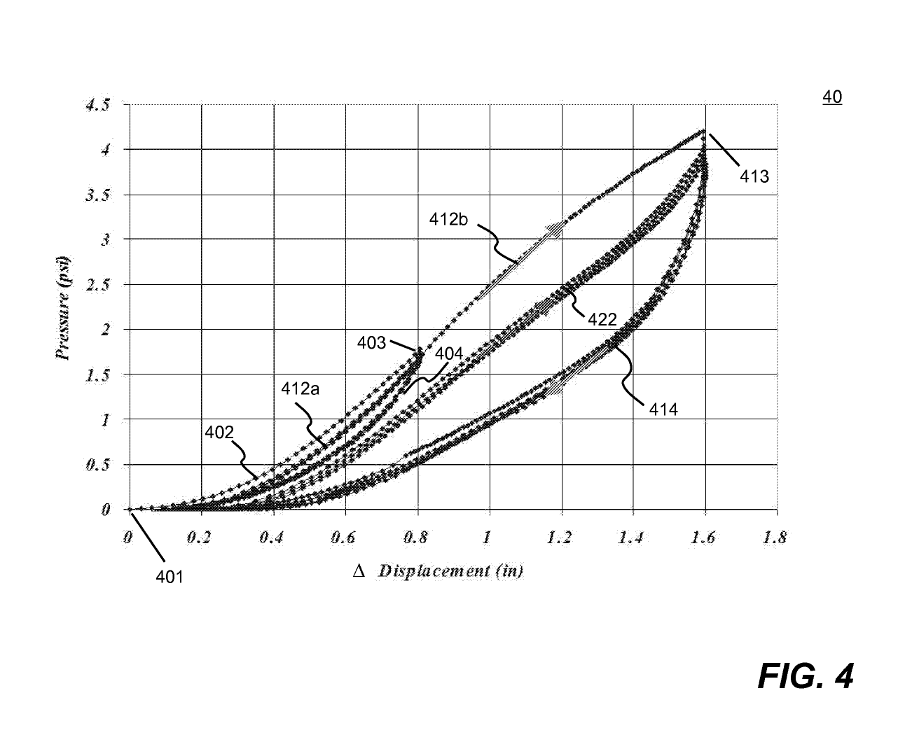

FIG. 4 shows an exemplary pressure versus displacement-at-the-pole (P-Δ) curves 40 generated by the rubber-like material properties determination system 30 of FIG. 3A. The vertical axis of the P-A curves 40 represents the pressure P 338, while the horizontal axis represents the displacement-at-the-pole Δ 336.

Using the rubber-like material properties determination system 30, an rubber-like membrane specimen 315 is inflated and measured. In the beginning of the bi-axial tension test, there is neither pressure nor displacement at 401. As more fluids are pumped into the bi-axial tension test device 310, the displacement and the pressure increase accordingly following path 402 to reach a first pre-determined displacement (e.g., 0.8 inches) at 403. Then the specimen 315 is unloaded by reducing the pressure of the inflating fluids. The unloading phase following path 404 back to the original un-inflated state at 401. The specimen 315 is reloaded back to 403. The bi-axial tension test results show clearly that the reloading phase follows another path 412a, which is softer than the original loading phase path 402 but stiffer than the unloading path 404. Two more cycles of unloading and reloading of the specimen 315 are conducted thereafter.

Next, at 403 after three cycles of loading and reloading, the inflating fluids are increased to inflate the specimen 315 to a larger or second pre-determined displacement-at-the-pole (e.g., 1.6 inches) at 413 following path 412b. The path 412b is a path of loading specimen 315 in its virgin state again. The bi-axial tension test continues after that by repetitively unloading the specimen 315 to the original state 401 and reloading back to the second displacement-at-the-pole at 413. It is clear that the unloading phase follows path 414 and reloading phase follows path 422. The P-A curves 40 clearly demonstrate the Mullins effect, which includes a softer reloading path after the initial loading and reloading.

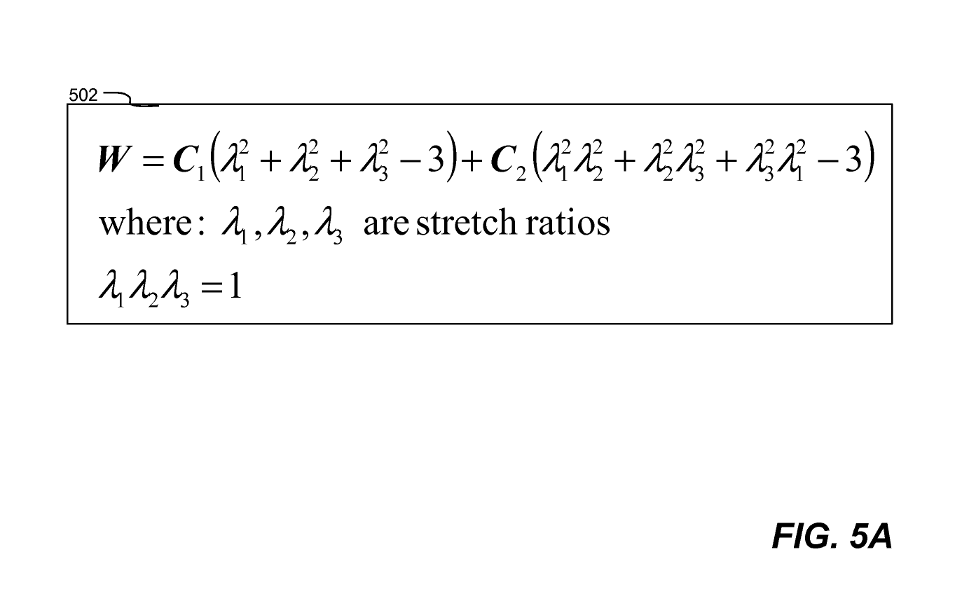

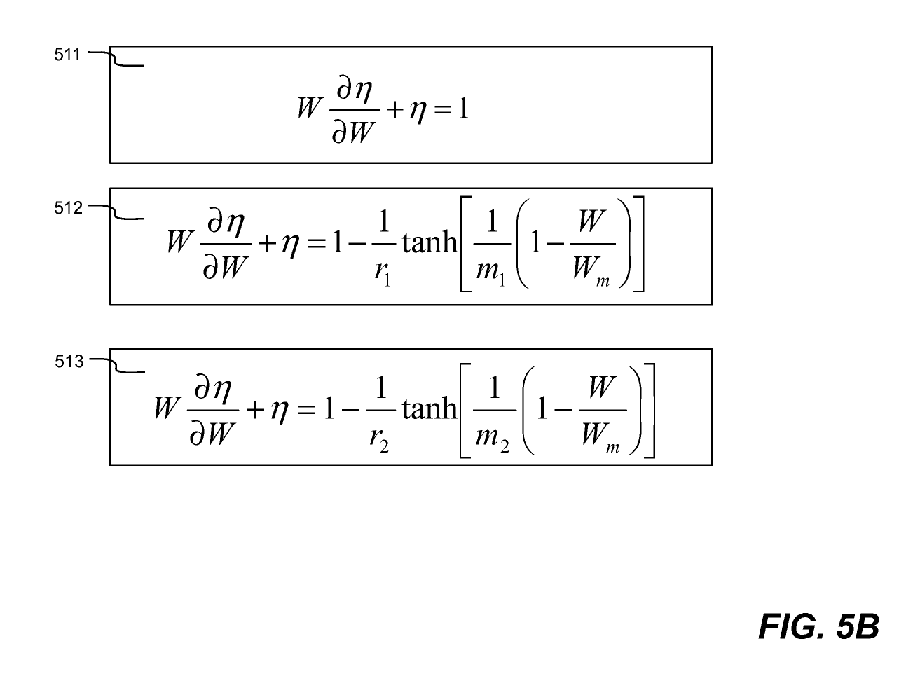

Referring back to process 10 and FIG. 5A, at step 104, a first set of numerical constants, C₁ and C₂, in the Mooney-Rivlin constitutive equation 502 used as strain-energy density function W (λᵢ) for representing material behaviors of the rubber-like material during the loading phase are determined from the test results (i.e., the pressure versus displacement-at-the-pole data). λᵢ are stretch ratios of the rubber-like material in three respective spatial dimensions. For incompressible material, λ₁λ₂λ₃=1. One exemplary technique is to use least square fit to determine the first set of numerical constants.

In order to represent the Mullins effect shown in the P-A curves 40 in FIG. 4. A new constitutive equation including Mullins effect damage function is defined as \tilde{W} (λᵢ).

\tilde{W}(λᵢ)=ηW(λᵢ) (1)

where W(λᵢ) is the strain-energy density function based on the initial loading (i.e., virgin state), η=η(W) is a damage function for the Mullins effect, and λ₇ are stretch ratios.

$$\frac{\partial \tilde{W}}{\partial {λ}_{i}} = η \frac{\partial W}{\partial {λ}_{i}} + W \frac{\partial η}{\partial {λ}_{i}} = ( η + W \frac{\partial η}{\partial W} ) \frac{\partial W}{\partial {λ}_{i}} \qquad ( 2 )$$

The Cauchy stresses (force per unit deformed area) are

$${t}_{1} = \frac{1}{{λ}_{2} {λ}_{3}} \frac{\partial \tilde{W}}{\partial {λ}_{1}} \qquad ( 3 )$$

There are two similar equations for t₂ and t₃.

The damage functions for the Mullins effect 512-513 are shown in FIG. 5B. In the initial loading phase, the damage function shows no damage value (i.e., one “1”) as shown in equation 511.

At step 106, a second set of numerical constants, r₁ and m₁, in an unloading-phase damage function 512 of FIG. 5B are determined. The unloading-phase damage function is used for modifying the strain-energy density function 502 and for representing material behaviors of the rubber-like material in the unloading phase. In the unloading-phase damage function 512, a hyperbolic tangent function with dimensionless operands is used. The dimensionless operands include a peak strain-energy value Wₘ immediately prior to the unloading phase (e.g., 403 and 413 of FIG. 4).

Next, at step 108, a third set of numerical constants, r₂ and m₂, in a subsequent reloading-phase damage function 513 of FIG. 5B are determined. The subsequent reloading-phase damage function is used for modifying the strain-energy density function 502 and for representing material behaviors of the rubber-like material in the reloading phase.

With the Mullins effect damage functions 512-513, the loading 402, 412b, unloading 404, 414 and subsequent reloading 412a, 422 phases follow different paths as shown in FIG. 4.

Finally, at step 110, a numerical model of the rubber-like material of interest is created by combining Mooney-Rivlin equation 502, the unloading-phase damage function 512 and the subsequent reloading-phase damage function 513 along with three sets of numerical constants. Because each set of the numerical constants contain two values, it would suggest that the formula set forth in the present invention is well formulated for numerically representing Mullins effect in a rubber-like material. The numerical model can be used in a computer-aided engineering analysis for a product made at least in-part of the rubber-like material of interest.

An approximate relationship between stretch ratio λ, the inflating pressure P 338 and the displacement-at-the-pole Δ 336 can be obtained as follows:

$$\begin{matrix}P = \frac{4 {C}_{1} H}{R} \{ \frac{2}{( \frac{Δ}{R} + \frac{R}{Δ} )} ( [ 1 - \frac{1}{{λ}^{6}} ] + α [ {λ}^{2} - \frac{1}{{λ}^{4}} ] ) \} & ( 4 ) \\ α = {C}_{2} / {C}_{1} & ( 5 )\end{matrix}$$

The relationship between λ and Δ is

$$λ = \frac{( \frac{Δ}{R} + \frac{R}{Δ} )}{2} {sin}^{- 1} ( \frac{2}{( \frac{Δ}{R} + \frac{R}{Δ} )} ) \qquad ( 6 )$$

where λ is the stretch ratio of the rubber-like material in the planar direction, R 334 is the radius of the circular membrane (e.g., rubber-like material specimen 315) and H 332 is the thickness of the circular membrane. When the Mullins effect damage function is considered, Equation (4) is modified by

$$( η + W \frac{\partial η}{\partial W} ) .$$

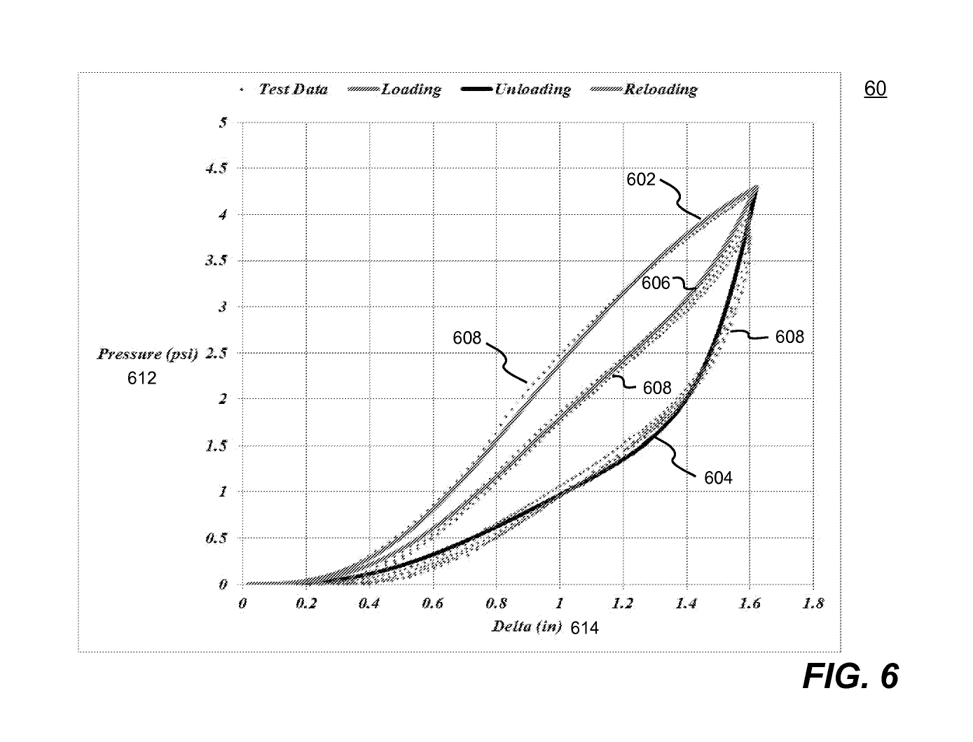

FIG. 6 is a diagram 60 showing an excellent correlation between computed results versus bi-axial tension test results. Diagram 60 is a plot of inflating pressure P 612 versus displacement-at-the-pole Δ (delta) 614. The test results are shown as dots (i.e., test data 608), while the computed results are shown in solid lines for three phases, loading phase 602, unloading phase 604 and reloading phase 606. To achieve the computed results, the values of numerical constants are as follows:

C₁=5, α=0.01; r₁=1.65, m₁=0.35; r₂=3.9 and m₂=0.4

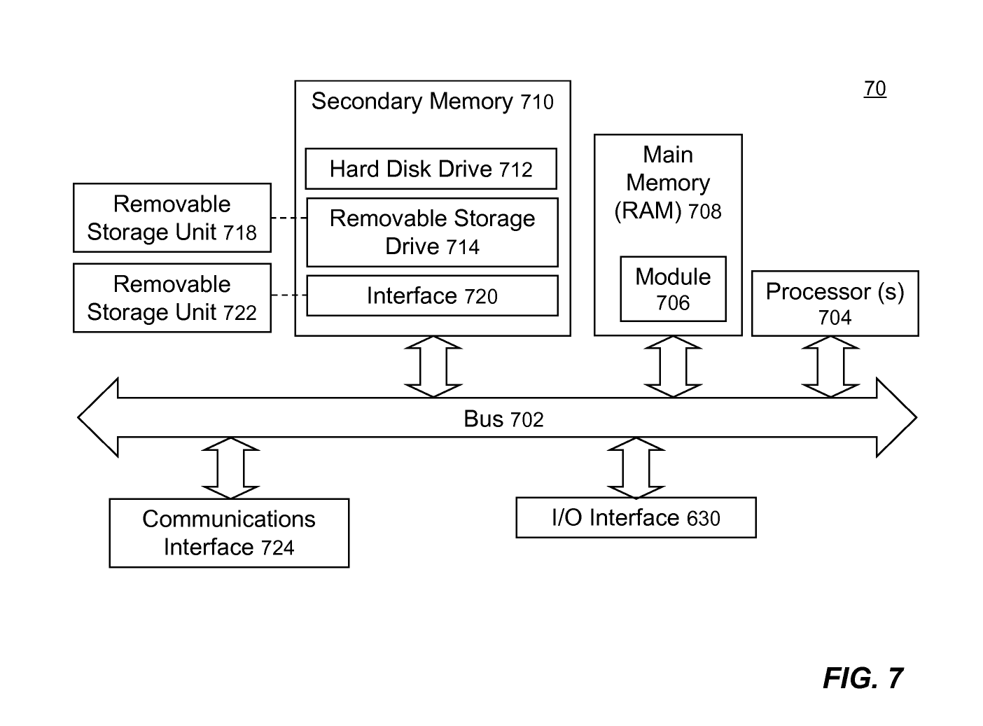

According to one aspect, the present invention is directed towards one or more computer systems capable of carrying out the functionality described herein. An example of a computer system 70 is shown in FIG. 7. The computer system 70 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 70 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 70. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 70. In general, Computer system 70 is controlled and coordinated by operating system (OS) software, which performs tasks such as process scheduling, memory management, networking and I/O services.

There may also be a communications interface 724 connecting to the bus 702. Communications interface 724 allows software and data to be transferred between computer system 70 and external devices. Examples of communications interface 724 may include a modem, a network interface (such as an Ethernet card), a communications port, a Personal Computer Memory Card International Association (PCMCIA) slot and card, etc. The computer 70 communicates with other computing devices over a data network based on a special set of rules (i.e., a protocol). One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 70. In this document, the terms “computer program medium” and “computer usable medium” are used to generally refer to media such as removable storage drive 714, and/or a hard disk installed in hard disk drive 712. These computer program products are means for providing software to computer system 70. The invention is directed to such computer program products.

The computer system 70 may also include an input/output (I/O) interface 730, which provides the computer system 70 to access monitor, keyboard, mouse, printer, scanner, plotter, and alike.

Computer programs (also called computer control logic) are stored as application modules 706 in main memory 708 and/or secondary memory 710. Computer programs may also be received via communications interface 724. Such computer programs, when executed, enable the computer system 70 to perform the features of the present invention as discussed herein. In particular, the computer programs, when executed, enable the processor 704 to perform features of the present invention. Accordingly, such computer programs represent controllers of the computer system 70.

In an embodiment where the invention is implemented using software, the software may be stored in a computer program product and loaded into computer system 70 using removable storage drive 714, hard drive 712, or communications interface 724. The application module 706, when executed by the processor 704, causes the processor 704 to perform the functions of the invention as described herein.

The main memory 708 may be loaded with one or more application modules 706 that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). The status of finite element analysis results is reported to the user via the I/O interface 730 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. Whereas Mooney-Rivlin constitutive equation has been shown and described for representing strain-energy density of a rubber-like material, other constitutive equations may be used for achieve the same, for example, neo-Hookean, Mooney, Ogden incompressible and Ogden compressible materials. Furthermore, the present invention can also apply to incompressible and compressible viscoelastic materials subject to very large deformation. Moreover, hyperbolic tangent function may be replaced by another equivalent mathematical function to achieve the same. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of creating a numerical model of rubber-like material suitable for computer-aided engineering analysis comprising:
receiving, in a computer system having an application module installed therein, pressure versus displacement-at-the-pole data obtained in a bi-axial tension test of a specimen of a rubber-like material of interest, the bi-axial tension test including loading, unloading and reloading phases;
determining, based on the pressure versus displacement-at-the-pole data by the application module, a first set of numerical constants, C₁ and C₂, in Mooney-Rivlin constitutive equation used as a strain-energy density function, W, of the rubber-like material during the loading phase, wherein the Mooney-Rivlin equation is as follows:
W=C₁(λ₁²+λ₂²+λ₃²−3)+C₂(λ₁²λ₂²+λ₂²λ₃²+λ₃²λ₁²−3)
where λ₁, λ₂ and λ₃ are stretch ratios of the rubber-like material in three respective spatial dimensions;
determining, by the application module, a second set of numerical constants, r₁ and m₁, in an unloading-phase damage function used for modifying the strain-energy density function to represent material behaviors of the rubber-like material during the unloading phase, the unloading-phase damage function containing a hyperbolic tangent function with dimensionless operands that include a peak strain-energy value, Wₘ, occurred immediately before the unloading phase, wherein the unloading-phase damage function is as follows:
$$W \frac{\partial η}{\partial W} + η = 1 - \frac{1}{{r}_{1}} tan h [ \frac{1}{{m}_{1}} ( 1 - \frac{W}{{W}_{m}} ) ] ;$$
determining, by the application module, a third set of numerical constants, r₂ and m₂, in a subsequent reloading-phase damage function used for modifying the strain-energy density function to represent material behaviors of the rubber-like material during the reloading phase, wherein the subsequent reloading-phase damage function is as follows:
$$W \frac{\partial η}{\partial W} + η = 1 - \frac{1}{{r}_{2}} tan h [ \frac{1}{{m}_{2}} ( 1 - \frac{W}{{W}_{m}} ) ] ;$$
and
combining the Mooney-Rivlin equation, the unloading-phase damage function and the subsequent reloading-phase damage function along with the first, second and third sets of numerical constants to form a numerical model of the rubber-like material to be used in a computer-aided engineering analysis of a product made at least in-part of the rubber-like material.

2. The method of claim 1, wherein the specimen is a circular membrane with a uniform thickness.

3. The method of claim 2, wherein the stretch ratios are obtained from an approximation formula including the pressure versus displacement-at-the-pole data and the specimen's radius.

4. The method of claim 3, wherein the stretch ratios are determined via an approximation formula based on the specimen's radius and the displacement-at-the-pole.

5. The method of claim 1, wherein the pressure versus displacement-at-the-pole data is converted to a dimensionless form.

6. A system for creating a numerical model of rubber-like material suitable for computer-aided engineering analysis comprising:
an input/output (I/O) interface;
a memory for storing computer readable code for an application module;
at least one processor coupled to the memory, said at least one processor executing the computer readable code in the memory to cause the application module to perform operations of:
receiving pressure versus displacement-at-the-pole data obtained in a bi-axial tension test of a specimen of a rubber-like material of interest, the bi-axial tension test including loading, unloading and reloading phases;
determining, based on the pressure versus displacement-at-the-pole data, a first set of numerical constants, C₁ and C₂, in Mooney-Rivlin constitutive equation used as a strain-energy density function, W, of the rubber-like material during the loading phase, wherein the Mooney-Rivlin equation is as follows:
W=C₁(λ₁²+λ₂²+λ₃²−3)+C₂(λ₁²λ₂²+λ₂²λ₃²+λ₃²λ₁²−3)
where λ₁, λ₂ and λ₂ are stretch ratios of the rubber-like material in three respective spatial dimensions;
determining a second set of numerical constants, r₁ and m₁, in an unloading-phase damage function used for modifying the strain-energy density function to represent material behaviors of the rubber-like material during the unloading phase, the unloading-phase damage function containing a hyperbolic tangent function with dimensionless operands that include a peak strain-energy value, Wₘ, occurred immediately before the unloading phase, wherein the unloading-phase damage function is as follows:
$$W \frac{\partial η}{\partial W} + η = 1 - \frac{1}{{r}_{1}} tan h [ \frac{1}{{m}_{1}} ( 1 - \frac{W}{{W}_{m}} ) ] ;$$
determining a third set of numerical constants, r₂ and m₂, in a subsequent reloading-phase damage function used for modifying the strain-energy density function to represent material behaviors of the rubber-like material during the reloading phase, wherein the subsequent reloading-phase damage function is as follows:
$$W \frac{\partial η}{\partial W} + η = 1 - \frac{1}{{r}_{2}} tan h [ \frac{1}{{m}_{2}} ( 1 - \frac{W}{{W}_{m}} ) ] ;$$
and
combining the Mooney-Rivlin equation, the unloading-phase damage function and the subsequent reloading-phase damage function along with the first, second and third sets of numerical constants to form a numerical model of the rubber-like material to be used in a computer-aided engineering analysis of a product made at least in-part of the rubber-like material.

7. The system of claim 6, wherein the specimen is a circular membrane with a uniform thickness.

8. The system of claim 7, wherein the stretch ratios are obtained from an approximation formula including the pressure versus displacement-at-the-pole data and the specimen's radius.

9. The system of claim 8, wherein the stretch ratios are determined via an approximation formula based on the specimen's radius and the displacement-at-the-pole.

10. The system of claim 6, wherein the pressure versus displacement-at-the-pole data is converted to a dimensionless form.
